(19) United States
(12) Patent Application Publication
(10) Pub. No.: US 2026/0086745 A1
(43) Pub. Date: Mar. 26, 2026

(54) NON-TRANSITORY COMPUTER-READABLE STORAGE MEDIUM, PRINT CONTROL DEVICE, AND PRINT CONTROL METHOD

(71) Applicant: SEIKO EPSON CORPORATION, TOKYO (JP)

(72) Inventors: Ryotaro KUBO, Suwa-shi (JP); Takuma KIMURA, Suwa-shi (JP)

(21) Appl. No.: 19/338,024

(22) Filed: Sep. 24, 2025

(30) Foreign Application Priority Data
Sep. 25, 2024 (JP) 2024-166114

(51) Int. Cl. G06F 3/12

(52) U.S. Cl. CPC G06F 3/1215; G06F 3/125; G06F 3/1253

(57) ABSTRACT

Provided is a non-transitory computer-readable storage medium storing a program executed by a computer, the program includes an acquisition processing of acquiring setting for manual double-surface print, first print processing of causing a print device to print print data of a first surface, a transmission processing of transmitting an interruption instruction for print processing to the print device until a user performs specific processing after start of the first print processing, and a second print processing of causing the print device to print print data of a second surface that is a surface opposite to the first surface after detecting that the specific processing is performed.

The present application is based on, and claims priority from JP Application Serial Number 2024-166114, filed September 25, 2024, the disclosure of which is hereby incorporated by reference herein in its entirety.

### BACKGROUND

### Technical Field

The present disclosure relates to a non-transitory computer-readable storage medium, a print control device, and a print control method.

### Related Art

A technology for enabling a user to perform print in various aspects is being studied.

For example, JP-A-2006-027042 discloses a printer that enables a user to perform manual double-surface print. The manual double-surface print means a print aspect in which a user performs print by supplying paper when printing on one surface of paper and then printing on the other surface of the same paper. A printer displays a message prompting a user to provide a print instruction for the other surface after printing on one surface is completed and paper is discharged. The printer outputs a paper feeding instruction according to a user’s print instruction for the other surface, and performs the print on the other surface by feeding paper from a predetermined paper feeding unit.

In the printer described in JP-A-2006-027042, when performing manual double-surface print, it is necessary to input a print instruction from a user not only when printing on one surface but also when printing on the other surface. In this way, since it is necessary to input a plurality of print instructions during print, there is a possibility that completion of manual double-surface print is delayed. Accordingly, it is desired to speed up the manual double-surface print.

### SUMMARY

According to an aspect of the present disclosure, there is provided a non-transitory computer-readable storage medium storing a program executed by a computer, the program includes an acquisition processing of acquiring a setting for manual double-surface print, a first print processing of causing a print device to print print data of a first surface, a transmission processing of transmitting an interruption instruction for print processing to the print device until a user performs specific processing after start of the first print processing, and a second print processing of causing the print device to print print data of a second surface that is a surface opposite to the first surface after detecting that the specific processing is performed.

According to another aspect of the present disclosure, there is provided a print control device including an acquisition unit that acquires setting for manual double-surface print, a first print control unit that causes a print device to print print data of a first surface, a transmission unit that transmits an interruption instruction for print processing to the print device until a user performs specific processing after print start of the print data of the first surface by the print device, and a second print control unit that causes the print device to print print data of a second surface that is a surface opposite to the first surface after detecting that the specific processing is performed.

According to another aspect of the present disclosure, there is provided a print control method performed by a computer including acquiring setting of manual double-surface print, causing a print device to print print data of a first surface, transmitting an interruption instruction of print processing to the print device until a user performs specific processing after print start of the print data of the first surface by the print device, and causing the print device to print print data of a second surface that is a surface opposite to the first surface after detecting that the specific processing is performed.

### BRIEF DESCRIPTION OF THE DRAWINGS

FIG. 1 is a block diagram illustrating an example of a print system according to Embodiment 1.

FIG. 2 is a block diagram illustrating an example of an external computer according to Embodiment 1.

FIG. 3 is a diagram illustrating a display screen for manual double-surface print according to Embodiment 1.

FIG. 4 is a block diagram illustrating an example of a printer according to Embodiment 1.

FIG. 5A is a sequence diagram illustrating a print flow in the print system according to Embodiment 1.

FIG. 5B is a sequence diagram illustrating a print flow in the print system according to Embodiment 1.

FIG. 6 is a block diagram illustrating an example of an external computer according to Embodiment 2.

### DESCRIPTION OF EMBODIMENTS

Hereinafter, embodiments of this disclosure will be described with reference to the drawings. For the sake of clarification of description, the following description and drawings are appropriately omitted and simplified. Each drawing to be referred to is merely an example for describing one or more embodiments. Not all of features or processing illustrated in any one of the drawings for describing an example embodiment are essential, and some of the features or processes may be omitted. In each drawing, the same elements will be given the same reference numerals, and redundant description thereof will be omitted as necessary.

### Embodiment 1

### Description of Configuration

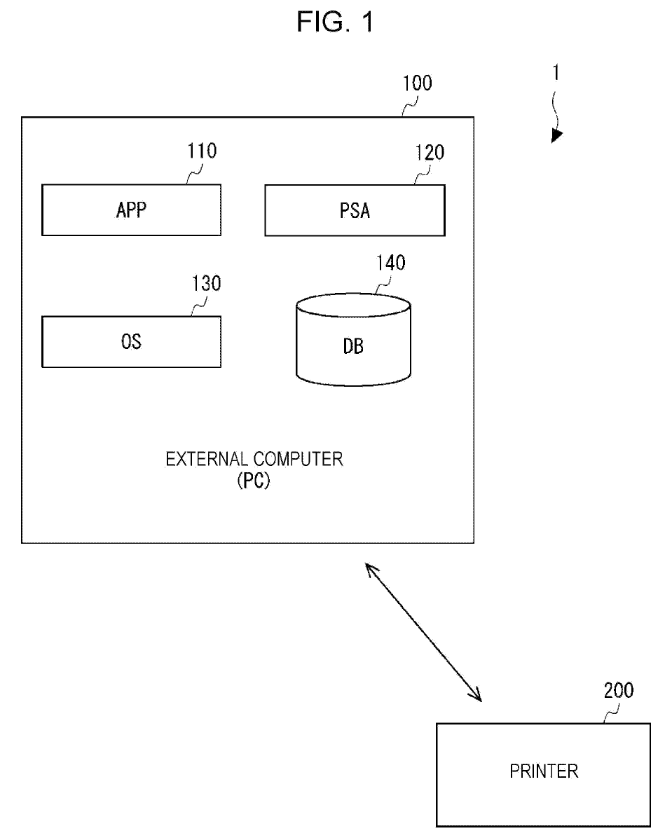

FIG. 1 is a block diagram illustrating an example of a print system according to the present disclosure. The print system 1 includes an external computer 100 and a printer 200. The external computer 100 is communicably connected to the printer 200 through a wire or wirelessly. The external computer 100 may be communicably connected to the printer 200 through a local area network (LAN) such as a wireless LAN. Further, the external computer 100 may be communicably connected to the printer 200 through, for example, the Internet.

The external computer 100 is a computer having a processor and a memory. The external computer 100 is, for example, an information processing device or an information processing terminal such as a personal computer (PC). The external computer 100 functions as a print control device that instructs the printer 200 to perform print. The printer 200 is any print device having a print function. The printer 200 can use any print method such as an ink jet method or an electrophotographic method. The printer 200 performs print according to an instruction of the external computer 100.

The external computer 100 includes an application (APP) 110, a print support application (PSA) 120, an operating system (OS) 130, and a database (DB) 140.

The APP 110 is application software capable of performing processing accompanied by print. The APP 110 may be, for example, document editing software, spreadsheet software, image editing software, or photo display software.

In addition, the APP 110 may display a basic print setting screen (hereinafter, also referred to as a basic setting screen) on a display unit 154 described below when print processing is performed. The basic print setting indicates a standard print setting that can be set by a user using the APP 110. The user operates an input unit 152 described below to select a desired print setting from the settings displayed on the basic setting screen, and then instructs the APP 110 to print data.

The PSA 120 is a general-purpose printer driver, and in this example, is a printer driver of OS 130 standard. The PSA 120 is software for operating the printer 200 by controlling the printer 200. When the PSA 120 acquires print data, the PSA 120 generates a print job including the print data. The print job is an instruction for causing the printer 200 to print an image indicated by the print data. Here, the PSA 120 may acquire print setting information from the DB 140 and add the print setting information to the print job.

In addition, the PSA 120 also functions as an extended application of the APP 110. Specifically, when the print data related to the APP 110 is printed, the PSA 120 may display an application print setting screen (hereinafter, also referred to as an application setting screen) on the display unit 154 according to an instruction from a user. Application print setting indicates print setting that can be set by a user by using the PSA 120. The user can designate a print aspect that cannot be set in the basic print setting through the application setting screen. Here, a situation is considered in which the user cannot set manual double-surface print in the basic print setting and can set the manual double-surface print in the application print setting. The manual double-surface print refers to an aspect of print in which, when printing on one surface of a certain paper is completed and then print is performed on the other surface of the paper, a user supplies paper during print. On the application print setting screen displayed on the display unit 154, a selection item for the manual double-surface print is displayed. By operating the input unit 152, a user selects a desired setting of the manual double-surface print from among settings displayed on the application setting screen, and then instructs the APP 110 to print data.

A user can designate information on print setting such as the number of print pages (that is, the amount of print), image quality, color of print, and the paper tray used for print through the basic setting screen or the application setting screen. In addition, the basic setting screen and the application setting screen may display print buttons for performing the print. When a user presses a print button through the input unit 152, print data, which is a target of the basic print setting or the application print setting, is printed. In addition, the basic setting screen may display a transition button for performing transition to the application setting screen. When a user presses the transition button through the input unit 152, the APP 110 calls the PSA 120 and causes the application setting screen to be displayed on the display unit 154. In addition, the application setting screen may display a re-transition button for returning to the basic setting screen. When a user presses the re-transition button through the input unit 152, the PSA 120 calls the APP 110 and causes the display unit 154 to display the basic setting screen.

Further, the PSA 120 may display, on the display unit 154, a notification screen for notifying a user of specific processing to be performed when the manual double-surface print is performed. The PSA 120 may switch notification content indicated on the notification screen according to at least one of paper tray information and model information of the printer 200. The PSA 120 can acquire the paper tray information as the print setting information input by a user. In addition, the PSA 120 can acquire the model information of the printer 200 by referring to, for example, the DB 140.

In addition, the PSA 120 generates print data of an odd-numbered page and print data of an even-numbered page (hereinafter, also respectively referred to as first print data and second print data) by using the print data generated by the OS 130. The first print data is data in which an odd-numbered page is excerpted among data of all pages which are print targets. The second print data is data in which an even-numbered page, which is a surface opposite to the odd-numbered page, is excerpted among data of all pages which are print targets. The odd-numbered page and the even-numbered page are respectively printed on the first surface and the second surface of paper, which are different from each other. The PSA 120 outputs the generated first print data and second print data to the printer 200.

The OS 130 is basic software that controls an operation of the external computer 100. The OS 130 may be, for example, Windows (registered trademark), but is not limited thereto. In the following description, an example in which the OS 130 is Windows will be described as appropriate.

The OS 130 generates print data (hereinafter, also referred to as all print data) of all print targets during print processing. The OS 130 outputs the generated all print data to the PSA 120. The first print data and the second print data are generated by using this all print data.

The DB 140 stores paper tray information or model information of the printer 200. The paper tray information is information indicating which paper tray of the printer 200 stores the paper on which the printer 200 performs a double-surface print process. The model information is information indicating a model of the printer. In addition, the DB 140 may store a print job log performed by the printer 200.

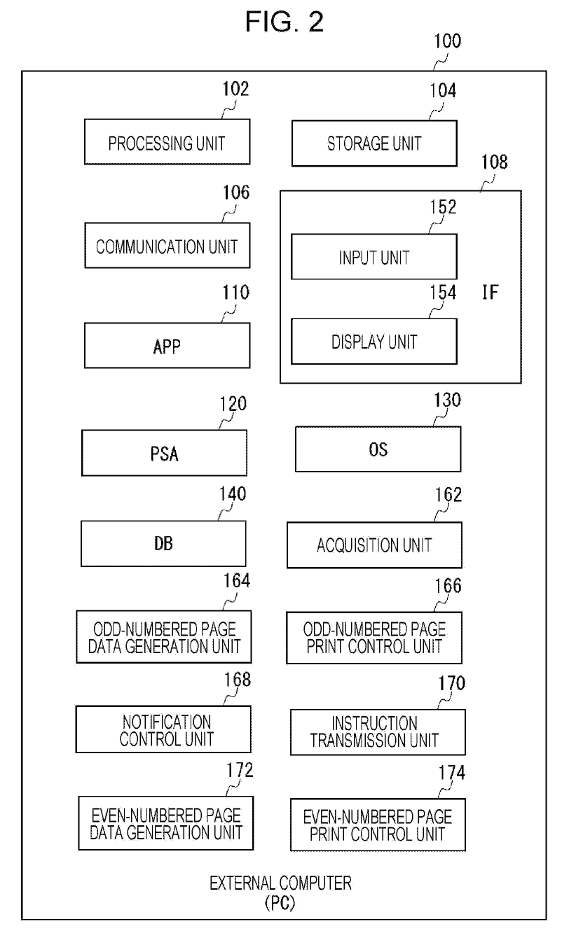

FIG. 2 is a block diagram illustrating an example of the external computer 100 according to Embodiment 1. The external computer 100 includes a processing unit 102, a storage unit 104, a communication unit 106, and an interface (IF) 108 as a main hardware configuration. The IF 108 includes an input unit 152 and a display unit 154. The processing unit 102, the storage unit 104, the communication unit 106, and the IF 108 may be coupled to each other through a data bus or the like.

The processing unit 102 is a processor such as a central processing unit (CPU), a micro processing unit (MPU), and an application specific integrated circuit (ASIC). The processing unit 102 includes one or more processors. The processing unit 102 has a function as a calculation device that performs control processing, calculation processing, and the like. The processing unit 102 controls the storage unit 104, the communication unit 106, and the IF 108.

The storage unit 104 is a storage device configured by one or more memories or storages, or a combination thereof. The memory is configured by a volatile memory, a non-volatile memory, or a combination thereof. The volatile memory may be, for example, a random access memory (RAM). The non-volatile memory may be, for example, a read only memory (ROM). The storage may be a flash memory, a hard disk drive (HDD), or a solid state drive (SSD). The storage unit 104 has a function of storing a control program, a calculation program, and the like executed by the processing unit 102. In addition, the storage unit 104 has a function of temporarily storing processing data and the like. The storage unit 104 can include a DB 140 described below. The storage unit 104 may store the print setting information.

The communication unit 106 performs processing necessary for the external computer 100 to communicate with another device through a communication network. The communication unit 106 can include a communication port, a router, a firewall, and the like. For example, the communication unit 106 performs processing for the external computer 100 to communicate with the printer 200. The communication unit 106 may perform processing for the external computer 100 to communicate with the printer 200 through a LAN such as a wireless LAN. In addition, the communication unit 106 may perform processing for the external computer 100 to communicate with the printer 200 through, for example, the Internet.

IF 108 is a user interface of the external computer 100. The IF 108 includes the input unit 152 which is an input device such as a button, a keyboard, or a mouse. A user inputs information to the external computer 100 by operating the input unit 152. For example, a user can input an instruction for setting of print and an instruction for performing print to the external computer 100 by operating the input unit 152.

In addition, the IF 108 includes the display unit 154 which is a data output device. The display unit 154 includes, for example, a display. The display unit 154 can display a basic print setting screen according to the control from the APP 110, and can display an application print setting screen or a notification screen according to the control from the PSA 120.

The input unit 152 and the display unit 154 may be configured as a physically integrated device, such as a touch screen or a touch panel.

In addition, the external computer 100 includes the APP 110, the PSA 120, the OS 130, and the DB 140 as the components described above. In addition, the external computer 100 further includes an acquisition unit 162, an odd-numbered page data generation unit 164, an odd-numbered page print control unit 166, a notification control unit 168, an instruction transmission unit 170, an even-numbered page data generation unit 172, and an even-numbered page print control unit 174 as components.

The acquisition unit 162, the odd-numbered page data generation unit 164, the odd-numbered page print control unit 166, the notification control unit 168, the instruction transmission unit 170, the even-numbered page data generation unit 172, and the even-numbered page print control unit 174 may be implemented by the PSA 120 as a function for manual double-surface print. For example, the processing unit 102 can implement each of the components by reading and executing a program related to the PSA 120 stored in the storage unit 104. In addition, a necessary program may be recorded on any non-volatile recording medium and installed in the external computer 100 as necessary, and accordingly, each of the components may be implemented.

In addition, each component may be implemented not only by software using a program but also by a combination of hardware, firmware, and software. In addition, each component may be implemented by using an integrated circuit, which is programmable by a user, such as a field-programmable gate array (FPGA) or a microcomputer. In this case, a program configured with the above-described respective components may be implemented by using this integrated circuit.

The acquisition unit 162 acquires manual double-surface print setting input by a user through the input unit 152. A user inputs the manual double-surface print setting selecting a desired manual double-surface print item with reference to the application setting screen displayed on the display unit 154.

The odd-numbered page data generation unit 164 performs first generation processing of generating the first print data by using all print data generated by the OS 130. The odd-numbered page print control unit 166 causes the printer 200 to print the first print data generated by the odd-numbered page data generation unit 164. Specifically, the odd-numbered page print control unit 166 causes the printer 200 to print the first print data by transmitting a print job including the first print data to the printer 200. This print processing can also be described as first print processing.

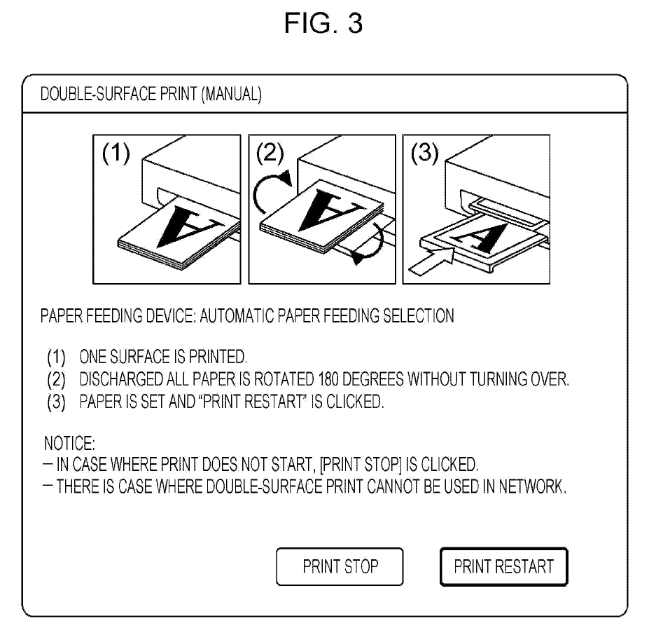

The notification control unit 168 causes the display unit 154 to display a notification of specific processing that a user needs to perform to print an even-numbered page in the manual double-surface print after the odd-numbered page print control unit 166 transmits the print job to the printer 200. FIG. 3 is an example of a notification displayed on the display unit 154. The notification illustrated in FIG. 3 displays a figure illustrating each procedure of manual double-surface print, and a description of each procedure. In addition, the notification also displays a print stop button and a print restart button for which a user can give an instruction through the input unit 152. In particular, the following content is described in the notification as specific processing to be performed by a user.

After odd-numbered pages are printed, all papers that are discharged are rotated by 180 degrees.

· Set the paper and click the print restart button displayed on the display unit 154.

A user can restart the manual double-surface print (that is, start print of the second print data) by performing each procedure shown in the notification and pressing the print restart button by using a mouse which is the input unit 152. In addition, a user can also stop the manual double-surface print by pressing a print stop button by using the mouse. When the print restart button or the print stop button is pressed, the notification control unit 168 stops the display of the notification on the display unit 154.

When a position of the paper tray of the printer 200 used in the double-surface print processing or a model of the printer 200 is changed, it is preferable to change notification content to properly guide a user for the manual double-surface print. For example, in the notification illustrated in FIG. 3, a figure and a description indicating that a paper tray is provided on a front surface of the printer 200 are displayed in the notification. However, when the paper tray is provided on a back surface of the printer 200 instead of the front surface of the printer 200, it is preferable that the figure and the description indicating that the paper tray is provided on the back surface of the printer 200 are displayed in the notification. Accordingly, the notification control unit 168 can switch the notification content according to at least one of the paper tray information and the model information of the printer 200.

The instruction transmission unit 170 transmits an interruption instruction on print processing to the printer 200 until it is determined that specific processing is performed by a user after the printer 200 completes a print job including the first print data. For example, when the notification illustrated in FIG. 3 is displayed on the display unit 154, the instruction transmission unit 170 determines that the print restart button displayed on the display unit 154 is pressed by a user, and determines that the specific processing is performed by the user by detecting an input by the input unit 152. However, a method of determining that the specific processing is performed by a user by detecting the input by the input unit 152 is not limited thereto.

In addition, the instruction transmission unit 170 can also transmit a print end instruction to the printer 200 when a user presses the print stop button in the notification. The printer 200 ends the print processing according to reception of the print end instruction.

When the even-numbered page data generation unit 172 determines that the specific processing is performed by a user by detecting an input by the input unit 152, the even-numbered page data generation unit 172 performs second generation processing of generating the second print data by using all print data generated by the OS 130. The even-numbered page print control unit 174 causes the printer 200 to print the second print data generated by the even-numbered page data generation unit 172. Specifically, the even-numbered page print control unit 174 causes the printer 200 to print the second print data by transmitting a print job including the second print data to the printer 200. This print processing may also be described as a second print processing.

In Embodiment 1, the even-numbered page data generation unit 172 generates the second print data including print data of all even-numbered pages after the specific processing is performed by a user. However, the even-numbered page data generation unit 172 may generate at least a part of the print data of all even-numbered pages before the specific processing is performed by a user. Details of this example will be described below in Embodiment 2.

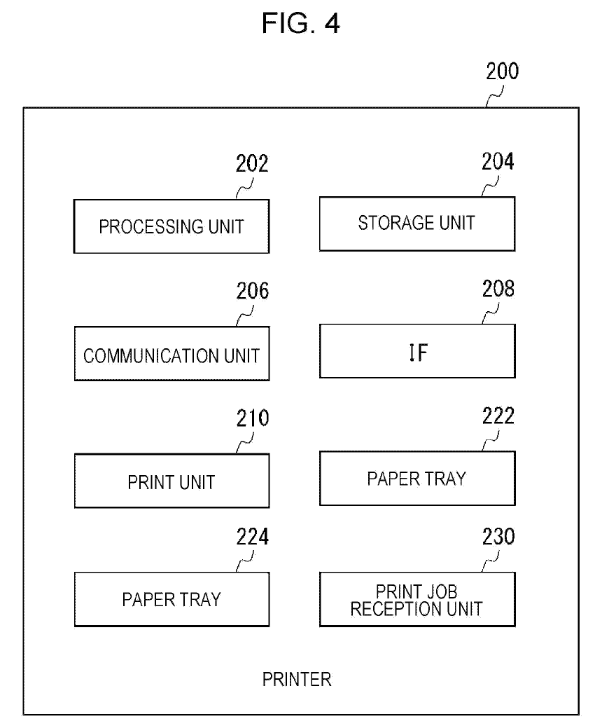

FIG. 4 is a block diagram illustrating an example of the printer 200 according to Embodiment 1. The printer 200 includes a processing unit 202, a storage unit 204, a communication unit 206, an IF 208, a print unit 210, paper trays 222 and 224, and a print job reception unit 230 as main hardware configurations. The processing unit 202, the storage unit 204, the communication unit 206, the IF 208, and the print unit 210 may be coupled to each other through a data bus or the like.

The processing unit 202 is a processor such as a central processing unit (CPU), a micro processing unit (MPU), and an application specific integrated circuit (ASIC). The processing unit 202 includes one or more processors. The processing unit 202 has a function as a calculation device that performs control processing, calculation processing, and the like. The processing unit 202 controls the storage unit 204, the communication unit 206, the IF 208, and the print unit 210.

The storage unit 204 is a storage device including one or more memories or storages, or a combination thereof. Since examples of the memory and the storage are the same as the example of the storage unit 104, the description thereof will be omitted. The storage unit 204 has a function of storing a control program, a calculation program, and the like executed by the processing unit 202. In addition, the storage unit 204 has a function of temporarily storing processing data and the like.

The communication unit 206 performs processing necessary for the printer 200 to communicate with another device through a communication network. The communication unit 206 can include a communication port, a router, a firewall, and the like. For example, the communication unit 206 performs processing for the printer 200 to communicate with the external computer 100. The communication unit 206 may perform processing for the printer 200 to communicate with the external computer 100 through a LAN such as wireless LAN. In addition, the communication unit 206 may perform processing for the printer 200 to communicate with the external computer 100 through the Internet.

IF 208 is a user interface of the printer 200. The IF 208 includes an input device such as a button, a keyboard, or a mouse, and an output device such as a display or a speaker. The IF 208 may be a device, in which an input device and the output device are integrally configured, such as a touch panel. The IF 208 receives an operation of a user to input data to the printer 200, and outputs information from the printer 200 to the user.

The print unit 210 has a print function for forming an image on paper, that is, a print medium. The print unit 210 includes a print engine. The print engine is a mechanical configuration that performs print of an image to a print medium. The print engine may have a mechanism for print with toner, for example, by an electrophotographic method. Alternatively, the print engine may have a mechanism for print by, for example, an ink jet method. In addition, the print engine may have a transport mechanism that transports a print medium.

The paper trays 222 and 224 are trays for a user to supply print paper by manual feeding. Although the printer 200 has two paper trays in this example, the printer 200 may have one or three or more paper trays. The number and position of the paper trays may change depending on model information of the printer 200. Therefore, as described above, the notification control unit 168 can switch notification content according to at least one of paper tray information or the model information of the printer 200 when manual double-surface print is performed. For example, when the paper tray 222 is used in manual double-surface print, the notification control unit 168 generates the notification content according to a position of the paper tray 222. When the paper tray 224 is used in manual double-surface print, the notification control unit 168 generates the notification content according to the position of the paper tray 224.

In addition, the printer 200 further includes a print job reception unit 230 as a component. The print job reception unit 230 can be implemented by executing a program, for example, under the control of the processing unit 202. More specifically, the print job reception unit 230 can be implemented by causing the processing unit 202 to execute a program stored in the storage unit 204. In addition, the print job reception unit 230 may be implemented by recording a necessary program on any non-volatile recording medium and installing the program on the printer 200 as necessary.

The print job reception unit 230 receives a print job from the external computer 100. The print job reception unit 230 may be implemented by the communication unit 206. The received print job is output to the print unit 210. The print unit 210 performs print according to the print job. That is, the print unit 210 performs the print according to an instruction of the external computer 100.

### Description of Processing Flow

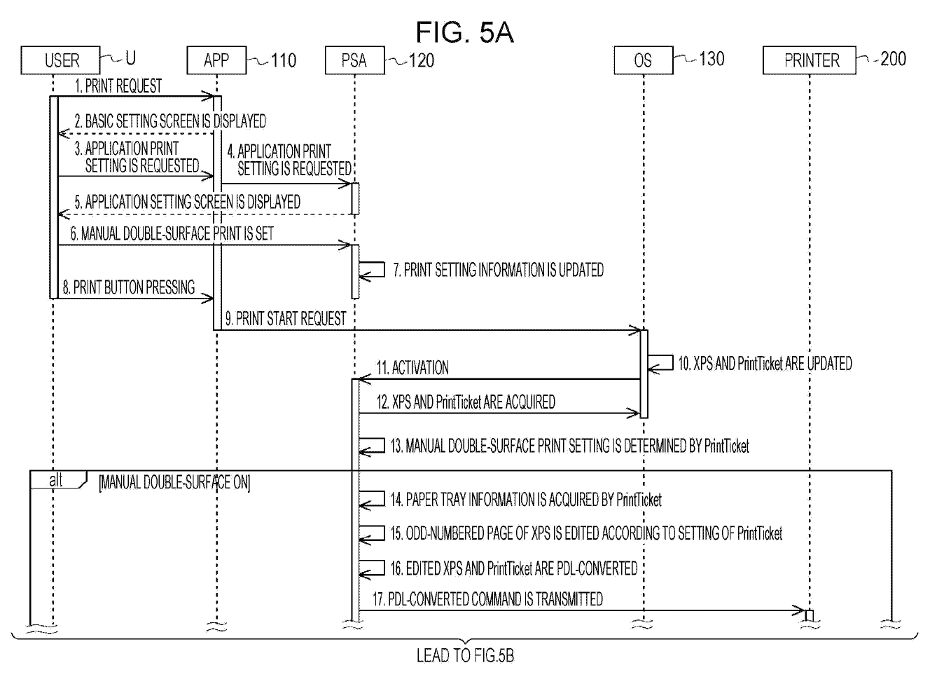

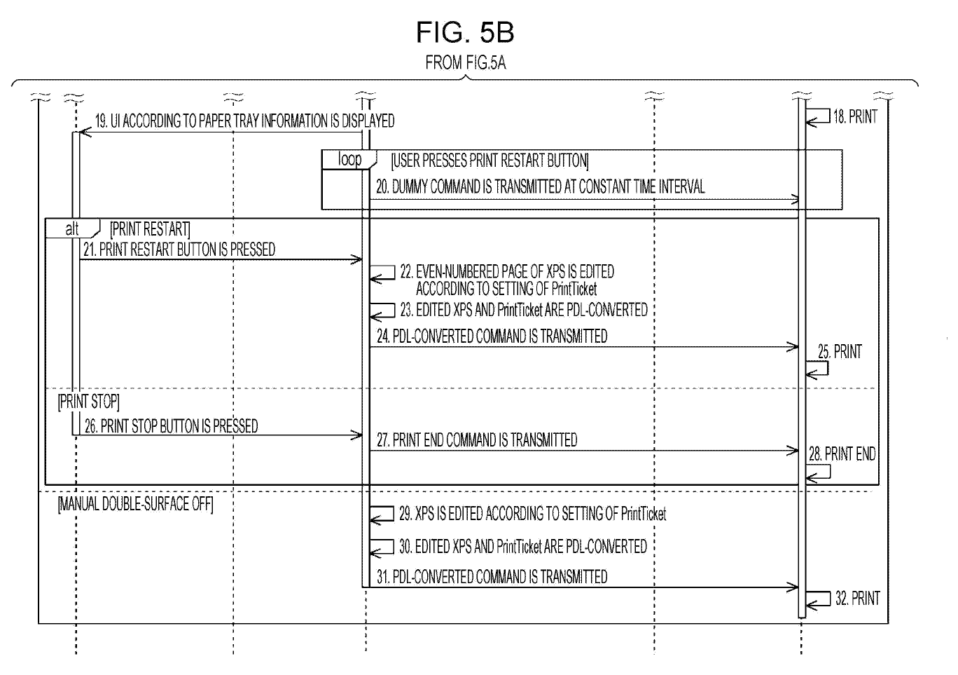

FIGS. 5A and 5B are sequence diagrams illustrating a print flow of the print system 1 according to embodiment 1. FIGS. 5A and 5B illustrate descriptions of a user U, the APP 110, the PSA 120, and the OS 130 which are components of the external computer 100, and the printer 200. Hereinafter, a processing flow and details thereof of the external computer 100 and the printer 200 will be described with reference to FIGS. 5A and 5B.

First, the user U operates the input unit 152 to output a print request for predetermined data to the external computer 100. 2. The APP 110 receives the print request and causes the display unit 154 to display a basic setting screen for printing the data designated by the print request. Thereby, the APP 110 causes the user U to set details of print.

In this example, the user U wants to print the predetermined data by manual double-surface print, but setting of the manual double-surface print cannot be made in the basic print setting. Accordingly, the user U operates the input unit 152 and presses a transition button displayed on a basic setting screen, and thereby, an application print setting request for enabling the setting of the manual double-surface print is output to the external computer 100. 4. The APP 110 outputs the application print setting request to the PSA 120 according to reception of the application print setting request. 5. The PSA 120 causes the display unit 154 to display the application setting screen according to the reception of the application print setting request. Thereby, the PSA 120 causes the user U to set details of print.

The user U inputs the setting of the manual double-surface print to the external computer 100 by operating the input unit 152 with reference to the application setting screen displayed on the display unit 154. 7. The PSA 120 updates information on print setting stored in the DB 140 according to the reception of the manual double-surface print setting.

The user U outputs a print start request to the APP 110 by pressing a print button displayed on the application setting screen through the input unit 152. 9. The APP 110 outputs the print start request to the OS 130 according to reception of the print start request. 10. The OS 130 generates extensible markup language (XML) paper specification (XPS) picturing data of the data which is a print start target according to the reception of the print start request. The XPS picturing data is the above-described all print data. In addition, the OS 130 updates PrintTicket which is the print setting. The OS 130 may generate the PrintTicket indicating that print to be performed is manual double-surface print with reference to the print setting information stored in the DB 140.

Thereafter, the OS 130 outputs an instruction to the PSA 120 to activate a function for the manual double-surface print. Hereinafter, each function to be performed by the PSA 120 will be described by using the acquisition unit 162, the odd-numbered page data generation unit 164, the odd-numbered page print control unit 166, the notification control unit 168, the instruction transmission unit 170, the even-numbered page data generation unit 172, and the even-numbered page print control unit 174, which are described above.

The acquisition unit 162 acquires the XPS picturing data and the PrintTicket generated by the OS 130 according to reception of a startup instruction from the OS 130. 13. The acquisition unit 162 determines whether the manual double-surface print is set by reading the acquired PrintTicket. The PrintTicket indicates the manual double-surface print setting input by the user U in 6.

Here, the acquisition unit 162 determines that the PrintTicket indicates the manual double-surface print setting. For example, in the PrintTicket, the manual double-surface print setting is set to ON. Based on the determination result, the PSA 120 performs following processing.

The acquisition unit 162 acquires information on a paper tray used for printing by reading the PrintTicket. 15. The odd-numbered page data generation unit 164 acquires print setting by reading the PrintTicket. The odd-numbered page data generation unit 164 generates data of an odd-numbered page in the XPS picturing data by editing the XPS picturing data based on the acquired print setting. 16. The odd-numbered page data generation unit 164 generates a first command, which is a command to the printer 200, by performing a page description language (PDL) conversion on the XPS picturing data and the PrintTicket of the generated odd-numbered page. The first command can be referred to as a print job including the above-described first print data. 17. The odd-numbered page print control unit 166 transmits the first command subjected to PDL conversion to the printer 200. 18. The printer 200 prints the data of the odd-numbered page included in the first command according to reception of the first command. By doing this, the print processing of the data of the odd-numbered page starts.

The notification control unit 168 generates notification content of specific processing that the user U needs to perform to print the even-numbered page, based on paper tray information acquired by the acquisition unit 162 in 14. The notification control unit 168 may generate the notification content of the specific processing by further using the model information of the printer 200 acquired by referring to the DB 140. The notification control unit 168 causes the display unit 154 to display the generated notification content. Here, the notification content displayed on the display unit 154 is as illustrated in FIG. 3. In the notification, a print restart button and a print stop button are displayed.

The instruction transmission unit 170 transmits a dummy command to the printer 200 at a constant time interval after the printer 200 completes a print job including the first print data. The dummy command is an instruction to interrupt the print processing. However, an example of the interruption instruction that can be transmitted by the instruction transmission unit 170 is not limited to the dummy command. The instruction transmission unit 170 may start transmitting the dummy command according to reception of, for example, a notification indicating that the print job is completed from the printer 200. The instruction transmission unit 170 may continuously transmit the dummy command when the notification generated by the notification control unit 168 is displayed on the display unit 154. In addition, a period during which the instruction transmission unit 170 transmits the dummy command to the printer 200 may partially overlap a period during which the print unit 210 performs print on the paper. The instruction transmission unit 170 repeatedly transmits the dummy command to the printer 200 until it is determined that the print restart button displayed in the notification is pressed by the user U.

The user U visually recognizes the notification displayed on the display unit 154 and performs specific processing required for the manual double-surface print. When the user U presses the print restart button at the end of the specific processing, the user U outputs a print restart request to the external computer 100. The notification control unit 168 stops displaying the notification onto the display unit 154 according to reception of the print restart request. In addition, the instruction transmission unit 170 stops the transmission of the dummy command to the printer 200 according to the reception of the print restart request.

According to the reception of the print restart request, the even-numbered page data generation unit 172 acquires print setting by reading the PrintTicket. The even-numbered page data generation unit 172 generates data of an even-numbered page in the XPS picturing data by editing the XPS picturing data based on the acquired print setting. 23. The even-numbered page data generation unit 172 generates a second command, which is a command to the printer 200, by performing PDL conversion on the XPS picturing data and the PrintTicket of the generated even-numbered page. The second command can be referred to as a print job including the above-described second print data. However, the print job related to the first command and a print job related to the second command are jobs derived from the print job for the entire manual double-surface print. 24. The odd-numbered page print control unit 166 transmits the second command, on which PDL conversion is performed, to the printer 200. 25. The printer 200 prints data of an even-numbered page included in the second command according to reception of the second command. By doing so, the print processing (second print processing) of the second print data is performed. Printing of data by the manual double-surface print is completed by the processing described above.

Hereinafter, processing performed when the user U presses a print stop button instead of the print restart button in 21 will be described. The user U presses the print stop button to output a print stop request to the external computer 100. 27. According to reception of the print stop request, the instruction transmission unit 170 generates a print end command to instruct the print end. Then, the instruction transmission unit 170 transmits the print end command to the printer 200. 28. The printer 200 ends the print processing performed by the print unit 210 according to the reception of the print end command.

Hereinafter, processing performed when the user U presses the print stop button instead of the print restart button in (21) will be described.

The user U outputs a print stop request to the external computer 100 by pressing the print stop button. 27. According to reception of the print stop request, the instruction transmission unit 170 generates a print end command to instruct the print end. Then, the instruction transmission unit 170 transmits the print end command to the printer 200. 28. The printer 200 ends the print processing performed by the print unit 210 according to the reception of the print end command.

In addition, processing performed when the acquisition unit 162 determines that setting of manual double-surface print is not indicated in the PrintTicket in 13 will be described. This case is, for example, a case where the setting of the manual double-surface print is set to be off in the PrintTicket. Based on the determination result, the PSA 120 performs following processing.

The PSA 120 acquires print setting by reading the PrintTicket. The PSA 120 edits the XPS picturing data based on the acquired print setting. 30. The PSA 120 generates a command to the printer 200 by performing PDL conversion on the edited XPS picturing data and the PrintTicket. The command can be referred to as a print job including all data which is a print target. 31. The PSA 120 transmits a command subjected to the PDL conversion to the printer 200. 32. The printer 200 prints all data according to reception of the command. The print of the data is completed by the processing described above.

In the above-described example, transmission processing of the first command shown in (17) is performed after information acquisition processing of a paper tray shown in (14), and then generation processing of the notification content of the specific processing shown in (19) is further performed. However, the processing shown in (14) may be performed after the processing of (17) and may be performed at the timing before the generation processing of the notification content of the specific processing shown in (19). The processing shown in (19) may be performed at any timing after the processing shown in (14).

### Description of Effect

In Embodiment 1, the external computer 100 performs following processing by executing a program related to the PSA 120. The acquisition unit 162 acquires manual double-surface print setting. The odd-numbered page print control unit 166 causes the printer 200 to print the print data of an odd-numbered page. The instruction transmission unit 170 transmits a dummy command to the printer 200 as an interruption instruction of print processing until a user performs specific processing after the print processing of the print data of the odd-numbered page starts. After detecting that the specific processing is performed, the even-numbered page print control unit 174 causes the printer 200 to print the print data of the even-numbered page.

As a variation, the external computer 100 may perform following processing by executing a program related to the PSA 120. The acquisition unit 162 acquires manual double-surface print setting. The even-numbered page print control unit 174 causes the printer 200 to print the print data of the even-numbered page. The instruction transmission unit 170 transmits a dummy command to the printer 200 as an interruption instruction of the print processing until a user performs specific processing after the print processing of the print data of the even-numbered page starts. After detecting that the specific processing is performed, the odd-numbered page print control unit 166 causes the printer 200 to print the print data of the odd-numbered page.

As described above, the external computer 100 transmits an interruption instruction of the print processing to the printer 200 between timing at which the printer 200 prints a page of the first surface and timing at which the printer 200 prints a page of the second surface during manual double-surface print. During the transmission of the interruption instruction, a print job for the entire manual double-surface print is not interrupted, and states of the external computer 100 and the printer 200 are continued. Accordingly, the print job for the entire manual double-surface print is not divided, one job is maintained as it is, and a user can give the printer 200 a setting instruction for the manual double-surface print to be input once. Therefore, the external computer 100 can speed up the manual double-surface print performed by the printer 200.

Following points are also obtained as additional effects by the external computer 100. Since it is not necessary to divide the print job of the entire manual double-surface print, the external computer 100 can generate a log in which start and end timings of print are clearly indicated as a log of the manual double-surface print and record the generated log in the DB 140. Accordingly, when a failure occurs in manual double-surface print, a user can easily specify a log related to the manual double-surface print from all the recorded print logs. Therefore, the external computer 100 can easily analyze logs by a user even when a failure occurs. In addition, when there is one job for manual double-surface print, a data amount of log to be generated can be reduced as compared with a case where a job is divided.

In addition, the external computer 100 can perform the above-described processing by using the PSA 120. Therefore, the external computer 100 can perform manual double-surface print even in an environment in which print processing is performed by using a general-purpose printer driver instead of a dedicated printer driver corresponding to the printer 200.

In addition, the notification control unit 168 of the external computer 100 can notify a user of content of specific processing. At this time, the notification control unit 168 can switch content of a notification according to at least one of paper tray information and model information of the printer 200. Accordingly, the external computer 100 can notify a user of proper content according to a print situation. Since a user can visually recognize the notification and accurately perform the specific processing, the manual double-surface print can be smoothly performed.

In addition, the even-numbered page data generation unit 172 of the external computer 100 can generate print data of an even-numbered page after detecting that specific processing is performed and before the processing of the even-numbered page print control unit 174. In addition, as the above-described variation, it is assumed a case where the odd-numbered page print control unit 166 of the external computer 100 causes the printer 200 to print the print data of the odd-numbered page after detecting that the specific processing is performed. In this case, the odd-numbered page data generation unit 164 can generate the print data of the odd-numbered page after detecting that the specific processing is performed and before the processing of the odd-numbered page print control unit 166. That is, when a user performs the specific processing for completing the manual double-surface print, the external computer 100 generates print data of the second surface which is a surface opposite to the previously printed first surface. Accordingly, when a user does not intend to complete the manual double-surface print and stops the print in the middle, the external computer 100 can suppress performing of unnecessary processing.

After detecting that specific processing is performed, the even-numbered page data generation unit 172 of the external computer 100 may generate a part of print data of an even-numbered page instead of all of the print data before processing of the even-numbered page print control unit 174. In the above-described variation, the odd-numbered page data generation unit 164 of the external computer 100 may generate a part of print data of an odd-numbered page instead of all of the print data after detecting that specific processing is performed, before processing of the odd-numbered page print control unit 166.

### Embodiment 2

In following Embodiment 2, description of the points described above in Embodiment 1 will be appropriately omitted, and a difference from Embodiment 1 will be mainly described.

### Description of Configuration

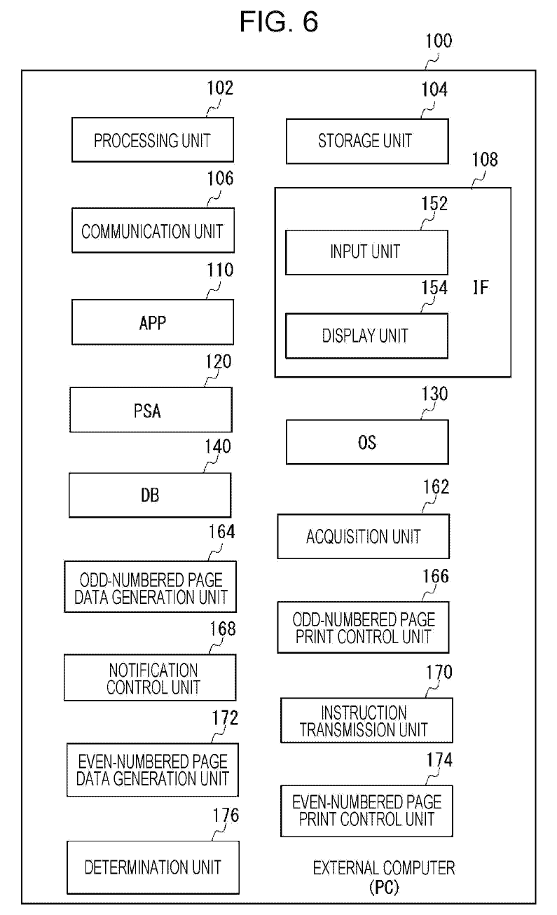

FIG. 6 is a block diagram illustrating an example of the external computer 100 according to Embodiment 2. The external computer 100 further includes a determination unit 176 as compared with the external computer 100 according to FIG. 2. After (13) illustrated in FIG. 5A, the determination unit 176 determines whether print of the print data of the odd-numbered page performed by the printer 200 satisfies a predetermined condition. Timing at which the determination unit 176 makes the determination may be any timing before the timing of (21) illustrated in FIG. 5B. For example, the determination unit 176 may make the determination at the timing after (17).

For example, the predetermined condition may be a condition in which the time required to print the print data of the odd-numbered page is longer than or equal to a predetermined time. In addition, the predetermined condition may be a condition in which the number of pages included in the print data of the odd-numbered pages is greater than or equal to a predetermined number of pages. In addition, the predetermined condition may be a condition in which image quality in printing the print data of the odd-numbered page is higher than or equal to a predetermined image quality. The determination unit 176 may determine whether print satisfies such a predetermined condition by using the PrintTicket which is print setting information acquired in (13).

When the determination unit 176 determines that the print of the print data of the odd-numbered page does not satisfy a predetermined condition, the external computer 100 performs the same processing as the processing described in Embodiment 1 in (15) and subsequent. Meanwhile, in case where the determination unit 176 determines that the print of the print data of the odd-numbered page satisfies a predetermined condition, the external computer 100 performs following processing.

In Embodiment 2, the even-numbered page data generation unit 172 generates a part or all of the print data of an even-numbered page from the XPS picturing data generated by the OS 130 after (13) and before (21). For example, after (17), the even-numbered page data generation unit 172 may generate a part of the print data of the even-numbered page in advance from the timing of (22). The processing of generating a part of the print data by using the even-numbered page data generation unit 172 and the processing of (19) or (20) may be performed in advance in any order, or both may be performed in parallel. Remaining data of the print data of the even-numbered page, which is not generated in advance, is generated in (22) and (23). Since details of the print data generation processing performed by the even-numbered page data generation unit 172 are as shown in (22) and (23), descriptions thereof will be omitted.

In addition, as another example, after (17), the even-numbered page data generation unit 172 may generate in advance all the print data of the even-numbered page from the timing of (22). In this case, when the external computer 100 receives a print restart request from the user U, the processing of (22) and (23) is not performed. At (24), the odd-numbered page print control unit 166 transmits a second command, which is generated in advance and is subjected to PDL conversion, to the printer 200. (25) Subsequent processing is as described in Embodiment 1.

### Description of Effect

As described above, the even-numbered page data generation unit 172 of the external computer 100 can generate at least a part of print data of an even-numbered page from XPS picturing data which is the print data before detecting that specific processing is performed. In addition, in the variation described in Embodiment 1, the odd-numbered page data generation unit 164 of the external computer 100 can generate at least a part of print data of an odd-numbered page from the XPS picturing data which is the print data before detecting that the specific processing is performed. Accordingly, the external computer 100 can generate at least a part of print data of a second surface before the second surface, which is a surface to be printed later, is printed. Accordingly, the external computer 100 can reduce time necessary for printing the second surface, and as a result, can speed up manual double-surface print.

In addition, the determination unit 176 can determine whether print processing of a first surface satisfies a predetermined condition. For example, the predetermined condition may be any one of the following: time required for print processing on a first surface is longer than or equal to a predetermined time, the number of pages included in print data of the first surface is greater than or equal to a predetermined number of pages, or image quality of print of the print data of the first surface is higher than or equal to a predetermined image quality. When the print processing of the first surface satisfies the predetermined condition, the external computer 100 can generate in advance at least a part of print data of a second surface. When a print situation does not satisfy a proper condition, the external computer 100 does not generate in advance the print data of the second surface. Therefore, when it is assumed that the time required for printing the second surface cannot be reduced, the external computer 100 can suppress performing of unnecessary processing that it is considered to be unlikely to obtain an effect by not generating in advance the print data of the second surface.

A threshold used for determination in relation to the predetermined condition may be not only one but also two or more. For example, the determination unit 176 can determine whether the time required for print processing on the first surface is longer than or equal to time T1, shorter than the time T1 and longer than or equal to time T2, or shorter than the time T2. However, T1 > T2. When the time required for the print processing on the first surface is longer than or equal to the time T1, after (17), the even-numbered page data generation unit 172 generates in advance all of the print data of an even-numbered page from the timing of (22). When the time required for the print processing on the first surface is shorter than the time T1 and is longer than or equal to the time T2, after (17), the even-numbered page data generation unit 172 generates in advance a part of the print data of the even-numbered page from the timing of (22). For example, the even-numbered page data generation unit 172 may generate in advance the half of the print data of the even-numbered page from the timing of (22). Then, among the print data of the even-numbered page, remaining data, which is not generated in advance, is generated in (22) and (23). In addition, when the time required for the print processing on the first surface is shorter than the time T2, the external computer 100 performs the same processing as the processing shown in Embodiment 1 in (15) and later. Not only the time required for the print processing on the first surface, but also the number of pages included in the print data of the first surface and image quality of print of the print data of the first surface can be provided with a plurality of thresholds for determination in the same manner. Thereby, the external computer 100 can properly control speed up depending on situations.

The present disclosure is not limited to the above embodiments, and can be appropriately changed in a range without departing from the gist. For example, an order of each processing shown in sequences in FIGS. 5A and 5B described above can be appropriately changed. In addition, one or more of each processing of the sequences in FIGS. 5A and 5B may be omitted.

Formats such as XPS, PrintTicket, and PDL used for the print processing illustrated in FIGS. 5A and 5B are examples, and other formats can be applied.

The notification control unit 168 may provide a notification by voice through a speaker (not illustrated) which is an output device of data, instead of or in addition to a notification displayed on a screen through the display unit 154. Content of the notification by voice is the same as content of the notification by the screen display described above.

Embodiment 1 describes a case where the OS 130 of the external computer 100 is Windows. However, the OS 130 is not limited to Windows, and may be any operating system such as the macOS (registered trademark) or the Linux (registered trademark).

In the above-described example, a program includes a group of commands (or software codes) for causing a computer to perform one or more functions described in the embodiment when being read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or another memory technology. In another example, the computer-readable medium or the physical storage medium includes a CD-ROM, a digital versatile disk (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. By way of non-limiting example, the transitory computer-readable medium or communication medium includes a propagating signal in an electrical, optical, acoustic, or another form. In addition, the program is included in a program product.

What is claimed is:

1. A non-transitory computer-readable storage medium storing a program executed by a computer, the program comprising:
an acquisition processing of acquiring a setting for manual double-surface print;
a first print processing of causing a print device to print print data of a first surface;
a transmission processing of transmitting an interruption instruction for print processing to the print device until a user performs specific processing after start of the first print processing; and
a second print processing of causing the print device to print print data of a second surface that is a surface opposite to the first surface after detecting that the specific processing is performed.

2. The non-transitory computer-readable storage medium according to claim 1, wherein
the program is a print support application.

3. The non-transitory computer-readable storage medium according to claim 1, wherein
the program further causes the computer to perform notification control processing of notifying the user of content of the specific processing and switching content of the notification according to at least one of paper tray information and model information of the print device.

4. The non-transitory computer-readable storage medium according to claim 1, wherein
the program further causes the computer to perform first generation processing of generating at least a part of print data of the second surface after detecting that the specific processing is performed, and before the second print processing.

5. The non-transitory computer-readable storage medium according to claim 1, wherein
the program further causes the computer to perform second generation processing of generating at least a part of print data of the second surface before detecting that the specific processing is performed.

6. The non-transitory computer-readable storage medium according to claim 5, wherein
the program further causes the computer to perform determination processing of determining whether the first print processing satisfies a predetermined condition, and
the second generation processing is performed before it is detected that the specific processing is performed when the first print processing satisfies the predetermined condition.

7. The non-transitory computer-readable storage medium according to claim 6, wherein
the predetermined condition is a condition in which time taken for the first print processing is longer than or equal to a predetermined time.

8. The non-transitory computer-readable storage medium according to claim 6, wherein
the predetermined condition is a condition in which a number of pages included in the print data of the first surface is greater than or equal to a predetermined number of pages.

9. The non-transitory computer-readable storage medium according to claim 6, wherein
the predetermined condition is a condition in which image quality of the first print processing is higher than or equal to a predetermined image quality.

10. A print control device comprising:
an acquisition unit that acquires setting for manual double-surface print;
a first print control unit that causes a print device to print print data of a first surface;
a transmission unit that transmits an interruption instruction for print processing to the print device until a user performs specific processing after print start of the print data of the first surface by the print device; and
a second print control unit that causes the print device to print print data of a second surface that is a surface opposite to the first surface after detecting that the specific processing is performed.

11. A print control method performed by a computer comprising:
acquiring setting for manual double-surface print;
causing a print device to print print data of a first surface;
transmitting an interruption instruction for print processing to the print device until a user performs specific processing after print start of the print data of the first surface by the print device; and
causing the print device to print print data of a second surface that is a surface opposite to the first surface after detecting that the specific processing is performed.
